(19) United States
(12) Patent Application Publication
(10) Pub. No.: US 2025/0135255 A1
(43) Pub. Date: May 1, 2025

(54) ADDITIVE AND LIQUID COMPOSITION FOR FIREFIGHTING AND FOR FUME PROTECTION

(71) Applicant: SUEZ INTERNATIONAL, Paris La Défense Cedex (FR)

(72) Inventors: Eric ISSARTEL, Paris La Défense (FR); Clément TIXIER, Paris La Défense (FR); Marc Xavier JOUBERT, Paris La Défense (FR)

(21) Appl. No.: 18/838,953

(22) PCT Filed: Feb. 14, 2023
(86) PCT No.: PCT/EP2023/053586

§ 371 Date: Aug. 15, 2024

Related U.S. Application Data
(60) Provisional application No. 63/310,888, filed on Feb. 16, 2022.

(30) Foreign Application Priority Data
Feb. 16, 2022 (EP) 22305172.3

(51) Int. Cl. A62D 1/02; A62C 3/06; A62C 5/02

(52) U.S. Cl. CPC A62D 1/0071; A62C 3/06; A62C 5/02

(57) ABSTRACT

Aqueous additive comprising, as weight percentages based on the total weight of the additive: water: balance to 100%, 10% to 30% of a hydroxylated carbon-based component chosen among sucrose, fructose, glucose, sorbitol, pentaerythritol and its derivatives, maltose, arabinose, glycerol and its derivatives, and mixtures thereof, PO₄³⁻ ions in an amount expressed as a weight content of phosphorus pentoxide P₂O₅ ranging between 15% and 37%, 2% to 15% of NH₄⁺ ions, 1% to 15% of a non-fluorinated surfactant chosen among an anionic surfactant, a non-ionic surfactant and mixtures thereof, 7% at most of a corrosion inhibitor, 7% at most of a stabilizer, 5% at most of a thickening agent, 3% at most of other components.

### TECHNICAL FIELD

The present invention relates to a liquid composition as well as to an additive which once diluted in an aqueous liquid, can result in the liquid composition. It further relates to a method for fighting a flammable liquid fire with the composition as well as to a method for protecting from fumes and vapors.

### PRIOR ART

Firefighting products are designed to fight specific types of burning material. For instance, a firefighting product intended for fighting a non-liquefiable solid fire is generally not designed to fight a flammable liquid fire and vice versa. In particular, few flame retardant products intended to fight a non-liquefiable solid fire, such as the one taught in WO 2018/134393 A1, are also adapted to fight a flammable liquid fire.

Indeed, the most common technique known in the art for fighting a flammable liquid fire consists in mixing water with one or more foaming agents so as to generate a liquid foam and then spraying this foam on top of the surface of the flammable liquid.

The foam floats and forms a barrier on top of the flammable liquid. Thus, it prevents air to reach the flammable liquid which helps extinguishing the fire. Furthermore, it prevents the vapors emitted by the liquid from being dispersed into the atmosphere.

Foaming agents adapted to fighting a flammable liquid fire are usually selected based on the ability to generate a foam:
having a required expansion rate, generally lower than 20 for having a low expansion foam, typically between 20 and 200 for having a medium expansion rate, over 200 for having a high expansion foam,
presenting a settling rate adapted to the application,
resistant to contamination and destruction by contacting the flammable liquid,
resistant to reignition of the flammable liquid, and
more importantly, being filmogenic, i.e. capable of spreading and forming a film on top of the flammable liquid that allows the foam to “re-heal”.

Surfactants promoting foams having filmogenic properties are known as AFFF, acronym of “Aqueous Film Forming Foams”. A positive spreading coefficient C (i.e. C>0) characterizes a foam having filmogenic properties on a flammable liquid.

AFFF surfactants known in the art are organic fluorine surfactants such as perfluorooctane sulfonic acid (PFOS) and perfluorooctanoic acid (PFOA) which have been used for a long time. However, PFOS and PFOA are harmful to humans and the environment. PFOS has been banned in the European Union since 2011 while the use of PFOA as a firefighting agent is still permitted up to 2023 and 2025 under specific conditions.

Therefore, there is a need for a foaming firefighting product adapted for fighting a flammable liquid fire and/or containment of fumes and/or vapors, which is capable to spread such as to form a self-healing fire-resistant foam blanket on top of the flammable liquid, and which is free of any fluoride surfactant.

### SUMMARY OF THE INVENTION

The invention relates to an aqueous additive comprising, as weight percentages based on the total weight of the additive:
water: balance to 100%,
10% to 30% of a hydroxylated carbon-based component chosen among sucrose, fructose, glucose, sorbitol, pentaerythritol and its derivatives, maltose, arabinose, glycerol and its derivatives, and mixtures thereof,
PO₄³⁻ ions in an amount expressed as a weight content of phosphorus pentoxide P₂O₅ ranging between 15% and 37%,
2% to 15% of NH₄⁺ ions,
1% to 15% of a non-fluorinated surfactant chosen among an anionic surfactant, a non-ionic surfactant and mixtures thereof,
7% at most of a corrosion inhibitor,
7% at most of a stabilizer,
5% at most of a thickening agent, and
3% at most of other components.

The invention further relates to a liquid composition obtained by diluting the additive according to invention in an aqueous liquid with a dilution ratio ranging between 1% and 20%, the dilution ratio being the ratio of the additive volume over the sum of the aqueous liquid volume and the additive volume. The invention also relates to a process for preparing the composition according to the invention by diluting the additive in an aqueous liquid.

The invention also relates to a liquid composition, notably according to the invention, comprising as weight percentages based on the total weight of the composition: water: balance to 100%,
0.2% to 7% of at a hydroxylated carbon-based component chosen among sucrose, fructose, glucose, sorbitol, pentaerythritol and its derivatives, maltose, arabinose, glycerol and its derivatives, and mixtures thereof,
PO₄³⁻ ions in an amount expressed as a weight content of phosphorus pentoxide P₂O₅ ranging between 0.2% and 10%,
0.02% to 4% of NH₄⁺ ions,
0.03% to 3% of a non-fluorinated surfactant chosen among an anionic surfactant, a non-ionic surfactant and mixtures thereof,
0.6% at most of a corrosion inhibitor,
0.5% at most of a stabilizer,
1.5% at most of a thickening agent,
1% at most of other components.

Of course, the total sum of the weight percentages of the components of the additive cannot exceed 100%, and the total sum of the weight percentages of the components of the composition cannot exceed 100%.

As it will appear in more details through the following description, the inventors have highlighted that a liquid foam may be generated from the additive and/or the composition according to the invention, notably by diluting the additive into an aqueous liquid. The generated foam spreads efficiently on top of the surface of a burning flammable liquid. It forms a blanket covering substantially entirely the flammable liquid surface acting as a long-lasting barrier preventing air to reach the flammable liquid and promoting fire extinction. Furthermore, the inventors have highlighted that the foam obtained from the additive and the composition of the invention is surprisingly self-healing. This self-healing property delays of event prevents the flammable liquid to re-ignite after being extinguished.

This self-healing behavior has been unexpected as the composition is not adapted to produce a foam having filmogenic properties, since its spreading coefficient C is negative. Thus, the invention provides a way to produce a foam having “pseudo-filmogenic” properties while having a negative spreading coefficient C (i.e. C<0).

To the inventors knowledge, the invention provides for the first time a composition for fighting a flammable liquid fire free of any fluorinated surfactant which is capable to produce such a self-healing foam.

### DETAILED DESCRIPTION

The spreading coefficient C of a foam onto a flammable liquid is defined by the following relationship

$$C = {γ}_{S}^{F L} - {γ}_{S}^{C} - {γ}_{I}^{C - H}$$

wherein:
γ_{S}^{FL} is the flammable liquid surface tension;
γ_{S}^{C} is the surface tension of the composition for generating the foam;
γ_{I}^{C-F} is the interface tension between the composition and the flammable liquid;
the surface tensions γ_{S}^{F} and γ_{S}^{C} and the interface tension being measured at 20° C. and expressed in mN·m⁻¹.

Unless otherwise specified, the contents of the various components are given in weight percentage.

The surfactant is non-fluorinated, i.e. it does not contain any carbon-fluorine (C—F) bond. More specifically, the non-fluorinated surfactant is a non-fluorinated organic surfactant.

The non-fluorinated surfactant is chosen among an anionic surfactant, a non-ionic surfactant and mixtures thereof. The document “Encyclopedia of Chemical Technology, KIRK-OTHMER”, volume 22, p. 333-432, 3rd edition, 1979, WILEY, provides some definition of emulsifying properties and functions of surfactants, in particular p. 347-377 of this reference, for anionic and non-ionic surfactants.

The non-ionic surfactant may be chosen in the group consisting in alkyl- and polyalkyl-ethers of polyethylene oxide, oxyalkylenated alcohols, alkyl- and polyalkyl-ethers of polyethylene oxide, alkyl- and polyalkyl-sorbitan esters, polyoxyethylenated or not, alkyl- and polyalkyl-sorbitan ethers, polyoxyethylenated or not, alkyl- and polyalkyl-glycosides or polyglycosides, glycerol esters, polyoxyethylenated or non-polyoxyethylenated glycerol alkyl and polyalkyl ethers, gemini surfactants, cetyl alcohol, stearyl alcohol, poly(ethylene glycol)-block-poly (propylene glycol)-block-poly(ethylene glycol) non-ionic tri-block copolymers, also known as poloxamers, and mixtures thereof.

Preferably, the non-ionic surfactant is an alkylpolyglucoside, in particular having a Cn alkyl group with n ranging between 6 and 14, preferably between 8 and 10.

The anionic surfactants may be chosen in the group consisting in alkyl ether sulphates, carboxylates, amino acid derivatives, sulphonates, isethionates, taurates, sulphosuccinates, alkylsulphoacetates phosphates and alkylphosphates, polypeptides, metal salts of C10-C30 fatty acids, in particular C16-C25 fatty acids, in particular metal stearates and behenates, alkali metal salts of acetylphosphate, and mixtures thereof.

Preferably, the anionic surfactant is sodium lauryl sarcosinate.

In some embodiments, the non-fluorinated surfactant comprises at least, or even consists in the non-ionic surfactant. In other embodiments, the non-fluorinated surfactant consists in the anionic surfactant.

Preferably, the hydroxylated carbon-based component comprises sucrose and fructose and glucose.

Preferably, the hydroxylated carbon-based component comprises sugar, less than 10% of the sugar being crystallizable, as percentages by weight based on the sugar weight.

Preferably, the hydroxylated carbon-based component is derived from a sugar extraction process of a plant.

Preferably, the PO₄³⁻ and NH₄⁺ ions are provided in the composition and/or in the additive by ammonium polyphosphate, preferably by ammonium polyphosphate 10-34-0.

Preferably, the composition and/or the additive comprise NH₄⁺ ions in an amount such that the ratio of the weight content of P₂O₅ over the weight content of NH₄⁺ ions ranges between 3 and 4, preferably equals 3.4.

The weight content of phosphorus pentoxide P₂O₅ can be measured according to standard ISO 6878:2004. The weight content of NH₄⁺ ions can be measured by a Kjeldahl-type method according to standard ISO 5663:1984.

In some embodiment, the additive and/or the composition may comprise the thickening agent which preferably has thixotropic properties. A composition and/or an additive showing “thixotropic” rheological behavior has a viscosity which decreases over time when it is sheared and a viscosity which increases and stabilizes following a rest period, after said shear stops, to a value less than or equal to its initial value before said shear. A “thickening agent having thixotropic properties” is suitable for modifying the rheological behavior of a material to make it thixotropic, possibly after activation by adding an aqueous liquid.

Preferably, the thickening agent is chosen among xanthan gum, arabic gum, senegal gum, diutan gum, agar gum, acacia gum, cellulose ethers and mixtures thereof. Preferably, the thickening agent is chosen among xanthan gum, diutan gum and mixtures thereof.

As an alternative, the additive and/or the composition may be free of the thixotropic agent.

In some embodiments, the additive and/or the composition may comprise a stabilizer. The stabilizer is preferably a clay, preferably chosen among bentonite, sepiolite, montmorillonite, attapulgite and their mixtures. Preferably, the stabilizer is bentonite. In particular, the additive and/or the composition may comprise the thickening agent and a clay, which are particularly well adapted to fight a fire of flammable liquid which is miscible with water, for instance alcohol fires. In particular, the additive and/or the composition may comprise xanthan gum and bentonite.

In some other embodiments, the additive and/or the composition may be free of the stabilizer.

In some embodiments, the additive and/or the composition may comprise the corrosion inhibitor. The anti-corrosion agent may be chosen among benzotriazole, C12-C18 film-forming amines, potassium hexacyanoferrates (II or III) and their mixtures. The corrosion inhibitor prevents corrosion of the vessel which may contain the additive of the composition.

In some other embodiments, the additive and/or the composition may be free of the corrosion inhibitor.

Typically, the additive and/or the composition are essentially free of any fluorinated organic compound. In other words, the additive and/or the composition may comprise one or several components, different from the non-fluorinated surfactant, which comprise fluorine ions or one or more organic or mineral fluorinated compounds as impurities. Impurities are inevitable components that are introduced unintentionally with the raw materials used to manufacture the additive and/or the composition. Notably, the additive and/or the composition preferably comprise less than 0.03%, preferably less than 0.003% of their respective weight of fluorine. The fluorine content can be measured by calcination as for instance detailed in standard NFT90-004.

The “other components” are components which are different from water, the hydroxylated carbon-based component, the PO₄³⁻ and NH₄⁺ ions, the non-fluorinated surfactant, the corrosion inhibitor, the stabilizer, and the thickening agent. For instance, the other components may comprise an antimicrobial agent, an antifungal agent, a colorant, a non-aqueous solvent, a mineral salt, for instance NaCl, and mixtures thereof. The other components may comprise impurities.

The additive and/or the composition according to the invention, in particular the additive, may advantageously be packaged to be made available to firefighting personnel, for example in the form of receptacles or canisters or any other packaging means that is easily transportable. For example, it may be conveyed to the site of a fire in a tank towed by a truck.

The additive and/or the composition may be denser than the flammable liquid they are intended to fight. Notably, they may present a density greater than 1 kg·dm⁻³. In particular, the additive may present a density greater than 1.3 kg·dm⁻³.

Furthermore, the additive is preferably intended, after dilution in an aqueous liquid, to fighting a fire of a flammable liquid and/or to protect from fumes, notably acidic fumes, and/or vapors.

Preferably, the additive has a content by weight of the hydroxylated carbon-based component which is greater than 15%, even greater than 20%. Preferably, it has a content by weight of the hydroxylated carbon-based component which is less than 25%.

The additive preferably has a total content by weight of sucrose, glucose and fructose which is greater than 15%, even greater than 20% and/or less than 25%.

The additive is preferably saturated with the hydroxylated carbon-based component, the PO₄³⁻ ions and the NH₄⁺ ions. In other words, the saturated additive is such that any hydroxylated carbon-based component and/or component suited to bring PO₄³⁻ ions and NH₄⁺ ions added to the additive cannot dilute into the water contained in the additive. The person skilled in the art knows routinely how to determine the saturated state of a solution.

Notably, the amount of PO₄³⁻ ions in the additive can be such that the weight content of phosphorus pentoxide P₂O₅ is less than or equal to 23%.

In some preferred embodiments, the additive may comprise the thickening agent. Preferably, the additive has a content by weight of the thickening agent which is greater than or equal to 1%, notably greater than or equal to 2%, even greater than 3%.

The additive may comprise at least 1% of the corrosion inhibitor.

The additive may comprise at least 0.4% of the stabilizer.

The invention also relates to a process for manufacturing the additive according to the invention, the method comprising preparing a liquid mixture comprising a raw material comprising the hydroxylated carbon-based component, ammonium polyphosphate and the non-fluorinated surfactant.

Preferably, the raw material comprising the hydroxylated carbon-based component is a molasse, in particular chosen among a sugarcane molasse, a beet molasse, a date molasse and mixtures thereof.

A “Molasse” is a residue of the sugar industry obtained at the end of the sugar crystallization stage (in particular sucrose, glucose or fructose). The sugar of a molasse is substantially non-crystallizable and contains glucose and sucrose and fructose. It generally contains by weight a minimum of 30% carbohydrates, more generally between 40% and 55%, as well as mineral salts and proteins. The sugar of a carbon-based component is considered not to be “crystallizable” if it cannot be crystallized by the methods conventionally used in the sugar industry. Such methods are described for example in the article “Extraction of beet sugar”, by Alfa ARZATE, of Oct. 27, 2005, published by the Maple Syrup Research, Development and Technological Transfer Center, or in the article “The extraction of sugar”, by Prof. Mathlouthi and Ms. Barbara Rogé (CEDUS File). Molasses, which still contains sugar, but in a non-crystallizable form, is thus conventionally considered to be a waste product of this industry.

As for the liquid composition, preferably, it is intended to fight a fire of a flammable liquid and/or to protect from fumes, notably acidic fumes, and/or vapors.

The composition preferably has a content by weight of the hydroxylated carbon-based component which is greater than 1.0%, even greater than 1.5%. Preferably, it has a content by weight of the hydroxylated carbon-based component which is less than 6%.

The composition preferably has a total content by weight of sucrose, glucose and fructose which is greater than 1.0%, even greater than 1.5% and/or less than 6%.

The amount of PO₄³⁻ ions in the additive can be such that the weight content of phosphorus pentoxide P₂O₅ ranges between 0.7% and 2%.

In some preferred embodiments, the composition may comprise the thickening agent. Preferably, the composition has a content by weight of the thickening agent which is greater than or equal to 0.15%. It may have a content by weight of the thickening agent which is less than or equal to 1%, even less than or equal to 0.5%.

In some embodiments, the composition is obtained by diluting the additive in an aqueous liquid. Preferably, the aqueous liquid is freshwater or brackish water.

The dilution ratio preferably ranges between 2% and 10%. In particular, it may equal 3% or 6%.

The composition may comprise at least 0.05% of the corrosion inhibitor.

The composition may comprise at least 0.005% of the stabilizer.

Furthermore, the invention relates to a method for fighting a flammable liquid fire, the method comprising generating a liquid foam from the composition according to the invention and contacting the liquid foam with the surface of the flammable liquid such that the foam spreads on the flammable liquid and forms a pseudo-filmogenic blanket floating thereon.

Preferably, the flammable liquid is chosen among flammable liquids miscible with water, flammable liquids non-miscible with water and mixtures thereof. Such flammable liquids are defined in EN-1568-1 to EN-1568-4 standards.

For example, the flammable liquid is non-miscible with water and is chosen in the group consisting in heptane, diesel, kerosene, vegetable oil, animal oil, mineral oil and their mixtures. According to another example, the flammable liquid is miscible with water and is chosen in the group of liquids comprising alcohol groups, ketone groups, aldehyde groups, ether groups and their mixtures.

Preferably, for fighting a fire of a flammable liquids which is miscible with water, the composition comprises the thickening agent, and preferably the stabilizer.

Preferably, the liquid foam has an expansion rate which is at least 1.0, notably at least 1.5. Such a minimal expansion rate is optimal for fighting a flammable liquid fire. Furthermore, it may be of 20 at most, notably 10 at most. A skilled worker knows how to select and a low-expansion foam generation system to generate a foam having such a low expansion rate.

The invention also relates to a method for containment of fumes, notably acidic fumes, and/or vapors susceptible to be emitted by a material, the method comprising generating a liquid foam from the composition according to the invention and applying the foam on the material such as to form a barrier to the fumes and/or vapors.

Preferably, the liquid foam has an expansion rate which is at least 1.0, notably at least 1.5. Such a minimal expansion rate is optimal for covering the material and protecting from fumes. Notably, it favors a low settling rate which prevents water contained in the foam to drain and contact the material. Furthermore, the expansion rate may be lower than 20, notably lower than 10.

Preferably, for optimal containment of fumes and/or vapors, the additive and/or composition comprise the thickening agent. Preferably, they also comprise the stabilizer.

The material may comprise components which react with water such as to produce acidic fumes. For instance, the material may comprise thionyl chloride SOCl₂. For instance, the material may be a battery electrolyte, which may decompose into HCl fumes. Advantageously, the foam according to the invention prevents from adding water onto acid, while forming a gastight blanket covering the material.

Preferably, the liquid foam has an expansion rate which is at least 1.0, notably at least 1.5. Such a minimal expansion rate is optimal for covering the material and containing fumes and/or vapors. Notably, it favors a low settling rate which prevents water contained in the foam to drain and contact the material. Furthermore, the expansion rate may be lower than 20, notably lower than 10.

### FIGURES

The invention may be better understood from a reading of the following examples, which are not limiting and given for illustrative purposes only and from the appended figures, wherein:

FIG. 1 is a set of pictures of a spreading test of foam obtained from an example of the liquid composition according to the invention,

FIG. 2 is a set of pictures illustrating the firefighting and self-healing behavior of a foam obtained from another example of the liquid composition according to the invention,

FIG. 3 is a picture illustrating the location of the foam generator on a tank wall for large scale testing,

FIG. 4 is a set of pictures of extinguishing of an unleaded gasoline 98 fire, a) 20s and b) 62 s after application thereon on the foam of example 13,

FIG. 5 is a set of pictures of extinguishing of an unleaded gasoline 98 fire, a) 20s and b) 60 s after application thereon on the foam of example 14,

FIG. 6 is a set of pictures of an attempt to re-ignite unleaded gasoline 98 after application of the example 14 with a tray of gasoline, a) at application of the tray on the blanket of foam, b) 3s, c) 8s, d) 43s, e) 44s and f) 49s after application of the tray,

FIG. 7 is a set of pictures of extinguishing of an unleaded gasoline 98 fire, a) 65s and b) 180s after application thereon on the foam of example 15, and

FIG. 8 is a picture of a tank of unleaded gasoline covered by a film of an example of the composition according to the invention one week after settlement of the foam.

### EXAMPLES

The following raw materials have been used:
solution of liquid ammonium polyphosphate 10-34-0, referred to below as APP, provided by the company PRAYON or PHOSAGRO, comprising 34% of phosphorus pentoxide P₂O₅,
beet molasses provided by the company FRANCE MELASSE, comprising 50% of sugar,
xanthan gum provided by the company JUNGBUNZLAUER,
Sodium Lauryl sarcosinate anionic and non-fluorinated surfactant ORAMIX® L30 provided by the company SEPPIC,
Alkylpolyglucoside non-ionic and non-fluorinated surfactant SIMULSOL® B865 provided by the company SEPPIC,
clay Sepiolite provided by TOLSA,
potassium hexacyanoferrate II and III provided by AMPERE,

The examples followed by an asterix (*) refer to examples out of the invention.

The additives, which formulations are presented in table I, have been prepared in the following way. The raw materials have been separately weighed and mixed altogether.

TABLE 1

| | | | | | | | |
|---|---|---|---|---|---|---|---|
| Additive | I* | II* | III* | IV* | V* | VI | VII |

formulation (wt %)

| | | | | | | | |
|---|---|---|---|---|---|---|---|
| Molasse | | | | | 94.0 | 38.8 | 38.0 |
| APP solution | | 22.9 | 95.7 | 91.8 | | 54.8 | 53.7 |
| Surfactant Simulsol ® | 100 | 77.1 | 4.3 | 4.2 | 6.0 | 5.0 | 2.4 |
| Hexacyanoferrate II | | | | | | 0.7 | 0.7 |
| Hexacyanoferrate III | | | | | | 0.7 | 0.7 |
| Xanthan gum | | | | 4.1 | | | 4.1 |
| Clay | | | | | | | 0.4 |

Properties

| | | | | | | | |
|---|---|---|---|---|---|---|---|
| Density (kg · dm⁻³) | 1.147 | 1.207 | 1.378 | 1.382 | 1.371 | 1.377 | 1.398 |
| pH | 6.1 | 6.3 | 6.5 | 6.5 | 8.7 | 6.5 | 6.8 |
| Viscosity (Cps) at 30 rpm | 6870 | 6777 | | | | 112.0 | |
| Viscosity (Cps) at 60 rpm | | | 54.2 | 82.3 | 865 | 115.3 | 385.3 |

Viscosity has been measured with a Brookfield viscosimeter.

Compositions have then been prepared in a room at 15° C. by diluting the additives with either freshwater (FW) or brackish water (BW) which temperature has been 20° C. Brackish water has been prepared comprising for a total of 100%, 2.5% of NaCl, 1.10% of MgCl₂·H₂O, 0.16% of CaCl₂·H₂O, 0.40% of Na₂SO₄, the balance being water.

### Laboratory Tests

Foams have been generated from the different compositions and tested at the laboratory. Table 2 illustrates the properties of the compositions and corresponding foams.

TABLE 2

| | | Dilution | | | | | | | |
|---|---|---|---|---|---|---|---|---|---|
| | | ratio | Dilution | Spraying | Expansion | Settling | | Film | |
| Composition | Additive | (% vol) | water | hose | rate | rate | | formation | Versatility |
| 1* | I* | 6 | FW | UNI 86 | 6.91 | 2 min 37 s | | N | N |
| 2* | I* | 0.35 | FW | UNI 86 | 3.47 | 1 min 05 s | | N | N |
| 3* | II* | 6 | FW | UNI 86 | 8.02 | 2 min 18 s | | N | N |
| 4* | II* | 0.42 | FW | UNI 86 | 3.68 | 1 min 16 s | | N | N |
| 5* | III* | 6 | FW | UNI 86 | 3.04 | <1 | min | N | N |
| 6* | III* | 7.14 | FW | UNI 86 | 3.22 | 57 | s | Y | N |
| 7* | IV* | 6 | FW | UNI 86 | 2.19 | >12 | min | N | Y |
| 8* | IV* | 7.43 | FW | UNI 86 | 2.23 | no droplet | | N | Y |
| | | | | | | after 30 min | | | |
| 9* | V* | 5.1 | FW | UNI 86 | 3.95 | 1 min 24 s | | N | N |
| 10 | VI | 3 | BW | EN | 2.35 | >20 | min | Y | N |
| 11 | VI | 6 | BW | EN | 2.46 | >20 | min | Y | N |

| | | | | | | | | |
|---|---|---|---|---|---|---|---|---|
| 12 | VII | 5.91 | FW | UNI 86 | 1.84 | no droplet | Y | Y |
| | | | | | | after 30 min | | |

For examples 1 to 9 and 12, the foam has been produced with a standard UNI 86 type firefighting hose, with a flow rate of 11.4 l/min and a service pressure of 6.3±3 bar. For examples 10 and 11, the foam has been generated with a EN 1568-3, 2018 hose.

Measurements of the expansion rate have been performed according to EN 1568-3 and EN 1568-4 standards, 2018.

The settling rate has been measured as being the time required for 25% of the weight of the foam to have become liquid again.

To determine whether a foamed composition is adapted to form a film on top a flammable liquid, a foam is first generated from the exemplary composition with a hose and then deposited in a container comprising heptane. First, it is observed if a blanket forms on top of heptane. Then a blanket is brought through a hopper to the surface of the container. If ignition of heptane is limited in time and the blanket reforms immediately, the foamed composition is considered as being adapted to form a film.

To determine whether the composition is versatile, a foam is first generated from the composition with a hose and then deposited in a container comprising a in water-miscible liquid, for instance a polar solvent, in the present case acetone. The interface between the foamed composition and acetone is observed. If polymers are observed which grow in time, the foamed composition is considered as being versatile.

The foams obtained with examples 1 and 2 are the result of the mixture of a mere addition of surfactant to water. They cannot develop any film on top of heptane.

Replacement of a minor part of surfactant by APP, as in examples 3 and 4, does not make the foam adapted to form a film on top of heptane.

The foam of example 6, obtained from additive III, comprising 95.7% of APP solution and the remainder being surfactant, may form a film on top of heptane. However, its settling rate is too high for this film to remain on top of heptane during a fire. Thus, it is not fire-resistant enough.

Addition of xanthan gum according to additive IV does not result in any film foaming (see examples 7 and 8).

The foam of example 9, obtained from example V (comprising 94.0% of molasse and 6.0% of surfactant) is quickly destroyed and does not form any film or blanket on the surface of heptane.

Examples 10 and 11 illustrate the synergetic effect of a foam obtained from a composition comprising a hydroxylated-carbon based component, ammonium polyphosphate and an un-fluorinated non-ionic surfactant. The foam obtained by diluting additive VI at a dilution ratio of 3% and 6% respectively is stable in time (the settling rate is greater than 20 minutes) and results in a fire-resistant blanket.

Furthermore, addition of xanthan gum to the additive (see additive VII) makes the foam even more stable (no settling being observed after 30 min), film forming and versatile.

### Large Scale Tests

The following compositions of table 3 have been prepared.

TABLE 3

| Composition | Additive | Dilution ratio (%) | Dilution water |
|---|---|---|---|
| 13* | I* | 1 | FW |
| 14 | VI | 6 | FW |
| 15 | VII | 6 | FW |

Foams have been prepared from these liquid compositions examples and have been applied on a container of unleaded gasoline 98.

Foam obtained from composition 13 get destroyed as soon as it contacts the gasoline.

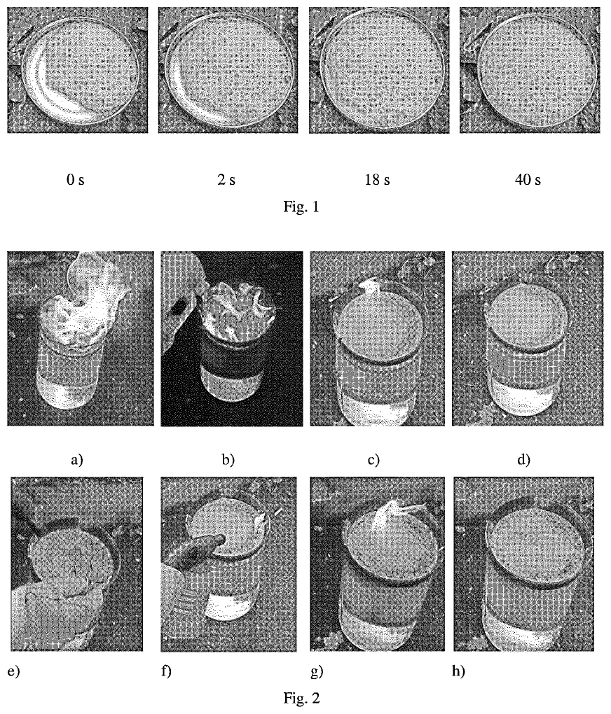

Foams obtained from both compositions 14 and 15 have spread and have been stable in time and have formed a stable and fire-resistant long-standing blanket on top of the flammable liquid. This may be observed on FIG. 1 where the foam has entirely spread on the flammable liquid surface 40s after having deposited the foam generated from composition 15.

Furthermore, as illustrated on FIG. 2) a), another container containing unleaded gasoline 98 was ignited and foams obtained from compositions 14 and 15 have been deposited on top of the firing gasoline.

Both foams have successfully spread onto the firing gasoline and form a blanket thereon until the fire has been put out. FIG. 2)b) to 2)d) illustrates the evolution of the gasoline fire 4s, 11s and 15s respectively after the foams have been deposited. Then after, as illustrated on FIG. 2e) the blanket was cut through its thickness to expose the gasoline and a flame has been approached from the gasoline such as to reignite if (FIG. 2)e)).

Both foams have then developed a self-healing behavior, reforming a leaktight blanket which once again has prevented air to reach the gasoline, as illustrated on FIG. 2)f) and 2)g). As observed on FIG. 2)g), after 9s, the fire has been put out again by the foam self-healing behavior of example 14.

In addition, foam of example 15 has shown an even better firefighting behavior against unleaded gasoline 98 than foam of example 14.

Further, some compositions have been tested at a larger scale at the firefighter training Center, Civaux France.

A 1.9 m diameter tank has been filled with 90 1 of unleaded gasoline 98.

The compositions have been prepared on site with a dosing pump injecting the additive into dilution water.

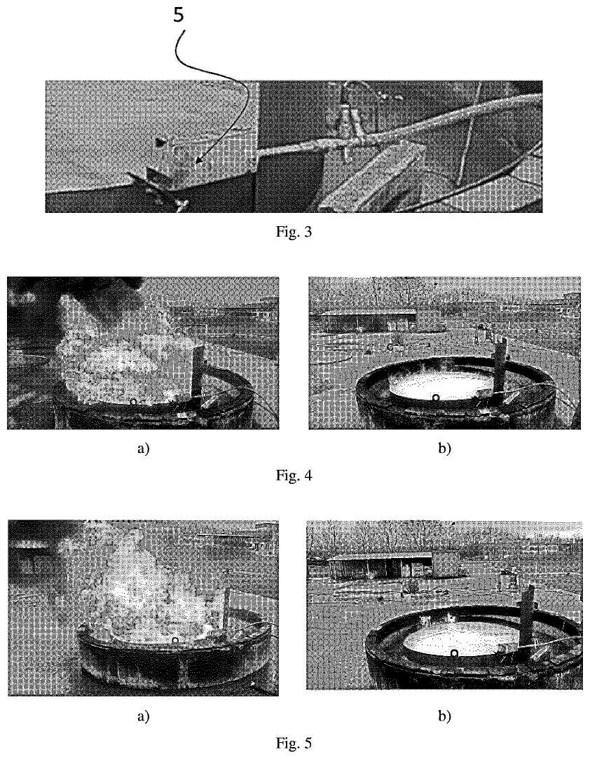

The foam has been generated from the composition by a foam generator 5 provided on a tank wall, as illustrated on FIG. 3. The flow rate has been 11.4 l/min, such as to spread 4.5 l·m⁻²·min⁻¹ of foam. The foam generator 5 presents a weir for pouring the foam onto the gasoline surface. By doing so, the foam deposited has had a low interaction with the flames, preventing intumescence of the composition. Furthermore, the flow rate of the foam has been sufficient to push the fire front while it has been spreading on the gasoline surface.

For every test, the foam has been deposited onto surface of the flammable liquid 90s after ignition of the latest. Once the fire has been extinguished, one has waited for 300 s before reignition of the fire.

Table 4 summarizes the results of the large-scale tests.

TABLE 4

| Example | 13* | 14 | 15 |
|---|---|---|---|
| fire extinguishing duration (s) | 63 | 154 | 210 |
| Duration of foam application (s) | 300 | 294 | 286 |
| volume of applied composition (l) | 58 | 58 | 53 |
| Time for reignition (min) | 4 | 8 | >45 |
| gasoline volume for reignition (l) | 2 | 2 | 5 |

Example 13*, out of the invention, shows that a foam generated from a mere mixture of water and non-fluorinated surfactant may quickly extinguish a fire, after 63s as observed respectively on FIGS. 4a) and 4)b). However, once a tray of gasoline on fire is provided on top of the foam, the latest resists only 4 minutes before the flammable liquid re-ignites.

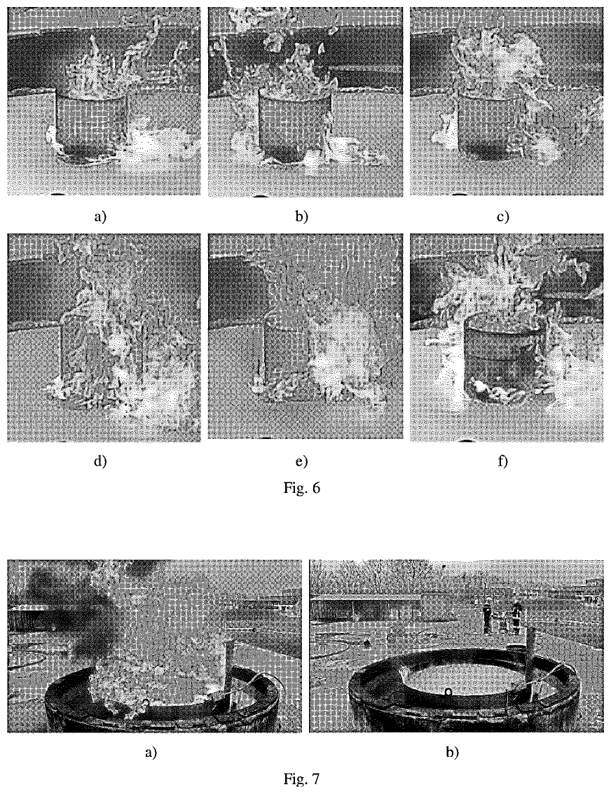

As observed on FIGS. 5a) and 5b), the foam of example 14 according to the invention has generated a blanket on top of the flammable liquid which has extinguished the fire after 154s. More especially, as compared with the foam of example 13, more time (8 minutes) has been necessary for the gasoline to re-ignite. Notably, as it can be observed on FIG. 6)a) to 6)f), once a tray of gasoline on fire is applied on the fire and tears the blanket of foam such as to re-ignite the gasoline contained in the tank underneath, the blanket progressively spreads and re-heals such as to entirely covering the tank of gasoline. This demonstrates the self-healing behavior of the foam generated from the additive/composition of the invention.

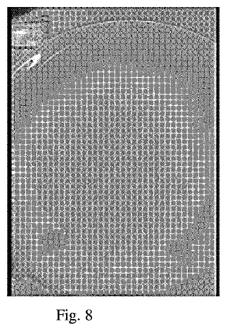

This self-healing behavior has also been observed when fighting a fire with the foam of Example 15, obtained from a composition having xanthan gum (see FIGS. 7a) and 7b)). More particularly, said foam has been particularly stable and fire-resistance. It has prevented any re-ignition of the fire, after providing 5 liters of gasoline with the tray and waiting 45 minutes.

These different tests have highlighted the pseudo-filmogenic behavior of the foams obtained from the compositions according to the invention.

### Comparison of the Filmogenic Properties

The following compositions of table 5 have been prepared.

TABLE 5

| | | | | | | | |
|---|---|---|---|---|---|---|---|
| Composition | 16 | 17 | 18 | 19 | 20 | 21 | 22 |

formulation (wt %)

| | | | | | | | |
|---|---|---|---|---|---|---|---|
| Surfactant Simulsol ® | 0.41 | | | | 0.40 | | |
| B865 | | | | | | | |
| Surfactant Oramix ® L 30 | | | | | | 0.40 | |
| A3F additive Totalon ® | | | | | | | 1.00 |
| BX | | | | | | | |
| Molasse | | 3.32 | | 3.39 | 3.18 | 3.18 | |
| APP solution | | | 4.59 | 4.68 | 4.40 | 4.40 | |
| Hexacyanoferrate II | | | | 0.06 | 0.06 | 0.06 | |
| Hexacyanoferrate III | | | | 0.06 | 0.06 | 0.06 | |
| Water | 99.59 | 96.68 | 95.41 | 91.81 | 91.90 | 91.90 | 99.00 |

Properties

| | | | | | | | |
|---|---|---|---|---|---|---|---|
| Surface tension γ_{S}^{C} | 27.1 | 44.6 | 68.9 | 39.47 | 27.5 | 33.47 | 15.8 |
| (mN · m⁻¹) | | | | | | | |
| Interface tension with | 1.6 | 21.2 | 45.33 | 20.1 | 2.13 | 4 | 1.97 |
| heptane γ_{I}^{C-F} (mN · m⁻¹) | | | | | | | |
| Spreading coefficient C | −8.47 | −45.57 | −94 | −39.34 | −9.4 | −17.24 | 2.46 |
| with heptane (γ_{S}^{FL} = | | | | | | | |
| 20.23 mN · m⁻¹) | | | | | | | |
| Interface tension with | 0.4 | 8.2 | 8.85 | 4.77 | 0.55 | | 0.37 |
| gasoline γ_{I}^{C-F} (mN · m⁻¹) | | | | | | | |
| Spreading coefficient C | −4.37 | −29.67 | −54.62 | −21.11 | −4.92 | | 6.96 |
| with gasoline (γ_{S}^{FL} = | | | | | | | |
| 23.13 mN · m⁻¹) | | | | | | | |

In table 5, to allow comparison between the different compositions, the total weight content of components except water is such that it corresponds to a 6% volume dilution of a corresponding additive into water.

Furthermore, the surface tension and the interface tension have been measured using the ring method with a tensiometer manufactured by LAUDA.

As it can be observed, only composition 22, out of the invention and obtained by dilution of the AFFF additive Totalon® BX containing a fluorine-based surfactant, presents positive spreading coefficient C which characterizes its filmogenic behavior adapted to generate a foam that spreads on top of heptane or gasoline.

All other compositions present a spreading coefficient C which is negative. However, apart from compositions 20 and 21, none of them can form self-healing a blanket of foam.

Furthermore, table 6 presents the properties of compositions corresponding to different dilution ratio of additive they have been obtained from.

TABLE 6

| Additive | | | | | | | | | |
|---|---|---|---|---|---|---|---|---|---|
| I* | | | VIII* | | | VI | | | |
| Composition (wt %) | | | | | | | | | |
| 23 | 24 | 25 | 26 | 27 | 28 | 29 | 30 | 31 | 32 |

Formulation

| | | | | | | | | | | |
|---|---|---|---|---|---|---|---|---|---|---|
| Surfactant | 0.18 | 0.29 | 0.55 | | | | 0.07 | 0.21 | 0.41 | 0.66 |
| Simulsol ® B865 | | | | | | | | | | |
| Molasse | | | | 3.39 | 5.57 | 10.72 | 0.83 | 1.63 | 3.22 | 5.29 |
| APP solution | | | | 4.68 | 7.69 | 14.81 | 1.14 | 2.25 | 4.45 | 7.31 |
| Hexacyanoferrate II | | | | 0.06 | 0.1 | 0.19 | 0.02 | 0.03 | 0.06 | 0.1 |
| Hexacyanoferrate III | | | | 0.06 | 0.1 | 0.19 | 0.02 | 0.03 | 0.06 | 0.1 |
| Water | 99.82 | 99.71 | 99.45 | 91.81 | 86.54 | 74.09 | 97.92 | 95.85 | 91.8 | 86.54 |
| dilution ratio | 6 | 10 | 20 | 6 | 10 | 20 | 1 | 3 | 6 | 10 |

Properties

| | | | | | | | | | | |
|---|---|---|---|---|---|---|---|---|---|---|
| Surface tension | 27.25 | 28 | 28.43 | 36.38 | 34.86 | 36.4 | 33.13 | 27.28 | 27.25 | 27.28 |
| γ_{S}^{C} (mN · m⁻¹) | | | | | | | | | | |
| Interface tension | 1.73 | 2.17 | 2 | 24.47 | 20.6 | 14.17 | | | 1.73 | 2 |
| with heptane γ_{I}^{C-F} | | | | | | | | | | |
| (mN · m⁻¹) | | | | | | | | | | |
| Spreading | −8.75 | −9.94 | −10.2 | −40.62 | −35.23 | −30.34 | | | −8.75 | −9.05 |
| coefficient C with | | | | | | | | | | |
| heptane (γ_{S}^{FL} = | | | | | | | | | | |
| 20.23 mN · m⁻¹) | | | | | | | | | | |
| Interface tension | 0.4 | 0.47 | 0.6 | 4.77 | 3.7 | 3.4 | 4.23 | 1.83 | 0.4 | 0.47 |
| with gasoline | | | | | | | | | | |
| γ_{I}^{C-F} (mN · m⁻¹) | | | | | | | | | | |
| Spreading | −4.52 | −5.34 | −5.9 | −18.02 | −15.43 | −16.67 | −14.23 | −5.98 | −4.52 | −4.62 |
| coefficient C with | | | | | | | | | | |
| gasoline (y_{S}^{FL} = | | | | | | | | | | |
| 23.13 mN · m⁻¹) | | | | | | | | | | |

As it can be observed from table 6, compositions 29 to 31 according to the invention all have a spreading coefficient C which is negative whatever the dilution ratio of additive VI ranging between 1% and 10%. All these compositions present a pseudo filmogenic behavior which results in a self-healing foam for fighting a fire.

As a comparison, compositions 23 to 28 all generate foams which do not spread nor self-heal preventing re-ignition of a fire. This is notably the case for compositions 26 to 28 which differ from compositions 29 to 32 by being free of any non-ionic surfactant.

Last, a blanket of foam generated from composition 31 and covering a tank of unleaded gasoline has been followed in time to observe its evolution.

As it can be observed on FIG. 8, one week after the foam has been generated, it has completely settled. Surprisingly, although the spreading coefficient C of this composition is negative, a film is observed which covers the entire surface of the tank and forms a dense blanket on the unleaded gasoline tank.

As it has been described throughout the present specification, the invention provides a new additive and a new composition which do not comprise any fluorine-based surfactant and successfully fight a flammable liquid fire and contain fumes and vapors, by forming a self-healing fire-resistant foam blanket.

1. Aqueous additive comprising, as weight percentages based on the total weight of the additive:
water: balance to 100%,
10% to 30% of a hydroxylated carbon-based component chosen among sucrose, fructose, glucose, sorbitol, pentaerythritol and its derivatives, maltose, arabinose, glycerol and its derivatives, and mixtures thereof,
PO₄³⁻ ions in an amount expressed as a weight content of phosphorus pentoxide P₂O₅ ranging between 15% and 37%,
2% to 15% of NH₄⁺ ions,
1% to 15% of a non-fluorinated surfactant chosen among an anionic surfactant, a non-ionic surfactant and mixtures thereof,
7% at most of a corrosion inhibitor,
7% at most of a stabilizer,
5% at most of a thickening agent,
3% at most of other components.

2. The additive according to claim 1, the non-ionic surfactant being chosen among alkyl- and polyalkyl-ethers of polyethylene oxide, oxyalkylenated alcohols, alkyl- and polyalkyl-ethers of polyethylene oxide, alkyl- and polyalkyl-sorbitan esters, polyoxyethylenated or not, alkyl- and polyalkyl-sorbitan ethers, polyoxyethylenated or not, alkyl- and polyalkyl-glycosides or polyglycosides, glycerol esters, polyoxyethylenated or non-polyoxyethylenated glycerol alkyl and polyalkyl ethers, gemini surfactants, cetyl alcohol, stearyl alcohol, poly(ethylene glycol)-block-poly(propylene glycol)-block-poly(ethylene glycol) non-ionic tri-block copolymers, also known as poloxamers, and mixtures thereof.

3. The additive according to claim 2, the non-ionic surfactant being an alkylpolyglucoside.

4. The additive according to claim 1, the anionic surfactant being chosen in the group consisting in alkyl ether sulphates, carboxylates, amino acid derivatives, sulphonates, isethionates, taurates, sulphosuccinates, alkylsulphoacetates phosphates and alkylphosphates, polypeptides, metal salts of C10-C30 fatty acids, alkali metal salts of acetylphosphate, and mixtures thereof.

5. The additive according to claim 4, the anionic surfactant being sodium lauryl sarcosinate.

6. The additive according to claim 1, the hydroxylated carbon-based component comprising sucrose and fructose and glucose.

7. The additive according to claim 1, the hydroxylated carbon-based component comprising sugar, less than 10% of the sugar being crystallizable, as percentages by weight based on the sugar weight.

8. The additive according to claim 1, the PO₄³⁻ and NH₄⁺ ions being provided in the additive by ammonium polyphosphate.

9. The additive according to claim 1, being saturated with the hydroxylated carbon-based component, the PO₄³⁻ ions and the NH₄⁺ ions.

10. The additive according to claim 1, comprising the thickening agent which is chosen among xanthan gum, arabic gum, senegal gum, diutan gum, agar gum, acacia gum, cellulose ethers and mixtures thereof.

11. Method for manufacturing the additive according to claim 1, comprising preparing a mixture comprising a raw material comprising the hydroxylated carbon-based, ammonium polyphosphate and the non-fluorinated surfactant.

12. Liquid composition obtained by diluting the additive according to claim 1 in an aqueous liquid with a dilution ratio ranging between 1 and 20, the dilution ratio being the ratio of the additive volume over the sum of the aqueous liquid volume and the additive volume.

13. Liquid composition comprising as weight percentages based on the total weight of the composition:
water: balance to 100%,
0.2% to 7% of a hydroxylated carbon-based component chosen among sucrose, fructose, glucose, sorbitol, pentaerythritol and its derivatives, maltose, arabinose, glycerol and its derivatives, and mixtures thereof,
PO₄³⁻ ions in an amount expressed as a weight content of phosphorus pentoxide P₂O₅ ranging between 0.2% and 10%,
0.02% to 4% of NH₄⁺ ions,
0.03% to 3% of a non-fluorinated surfactant chosen among an anionic surfactant, a non-ionic surfactant and mixtures thereof,
0.6% at most of a corrosion inhibitor,
0.5% at most of a stabilizer,
1.5% at most of a thickening agent,
1% at most of other components.

14. Method of fighting a flammable liquid fire, the method comprising generating a liquid foam from the composition according to claim 12 and contacting the liquid foam with the surface of the flammable liquid, such that the foam spreads on the flammable liquid and forms a pseudo-filmogenic blanket floating thereon.

15. Method according to claim 14, the flammable liquid being miscible with water or non-miscible with water as defined in EN-1568-1 to EN-1568-4 standards.

16. Method for containment of fumes, notably acidic fumes, and/or vapors susceptible to be emitted by a material, the method comprising generating a liquid foam from the composition according to claim 12, and applying the foam on the material such as to form a gastight blanket to the fumes and/or vapors.

17. The Method according to claim 14, the liquid foam having an expansion rate of at least 1.0.
